(19) United States
(12) Patent Application Publication
(10) Pub. No.: US 2023/0122263 A1
(43) Pub. Date: Apr. 20, 2023

(54) NEW CSI REPORT SETTING TO HASTEN CSI FEEDBACK FOR SVD-BASED PRECODING

(71) Applicant: QUALCOMM Incorporated, San Diego, CA (US)

(72) Inventors: Bo CHEN, Beijing (CN); Yu ZHANG, Beijing (CN); Jay Kumar SUNDARARAJAN, San Diego, CA (US); Pavan Kumar VITTHALADEVUNI, San Diego, CA (US); Ruifeng MA, Beijing (CN); Yeliz TOKGOZ, San Diego, CA (US); Krishna Kiran MUKKAVILLI, San Diego, CA (US); Hao XU, Beijing (CN); Tingfang JI, San Diego, CA (US)

(21) Appl. No.: 17/905,408

(22) PCT Filed: Apr. 24, 2020
(86) PCT No.: PCT/CN2020/086615

§ 371 Date: Aug. 31, 2022

(51) Int. Cl. H04L 5/00; H04B 7/06

(52) U.S. Cl. CPC H04L 5/0073; H04L 5/0048; H04B 7/0632; H04B 7/0452

(57) ABSTRACT

This disclosure provides systems, devices, apparatus and methods, including computer programs encoded on storage media, for a CSI report setting that hastens CSI feedback for SVD-based precoding. More specifically, a UE may receive a configuration from a base station for a CSI report setting for providing DL interference feedback to the base station. The configuration may include information indicating a measurement resource on which an interference measurement is performed for generating the DL interference feedback. The UE may transmit a SRS and the DL interference feedback to the base station, the DL interference feedback being independent of the SRS, such that the UE may receive pre-committed CSI-RS from the base station based on the transmitted SRS and DL interference feedback.

### BACKGROUND

### Technical Field

The present disclosure relates generally to communication systems, and more particularly, to a new channel state information (CSI) report setting to hasten CSI feedback for singular value decomposition (SVD)-based precoding.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

For reciprocity-based precoding operations, a user equipment (UE) may be configured to transmit a sounding reference signal (SRS) for performing an interference measurement on a CSI-interference measurement (CSI-IM) resource and/or a non-zero power (NZP) CSI-reference signal (RS) (NZP CSI-RS) resource. The UE may subsequently receive, from a base station, a beamformed CSI-RS based on the SRS transmission for performing a channel measurement, such that the UE may feedback a single-user (SU) channel quality indicator/rank indicator (CQI/RI) to the base station. The base station may then transmit pre-committed CSI-RS to the UE based on the SU CQI/RI and/or the SRS for the UE to further feedback a multi-user (MU) CQI to the base station. The UE may thereafter receive a physical downlink shared channel (PDSCH) transmission from the base station based on the MU CQI. As such, three round-trip cycles of transmissions/receptions among the UE and the base station may be required for the UE to receive the PDSCH from the base station.

Accordingly, interference/power feedback from the UE to the base station may be utilized to improve CSI feedback latency and reduce CSI-RS overhead. More specifically, the UE may perform an interference measurement on a measurement resource (e.g., CSI-IM and/or NZP CSI-RS) to generate downlink (DL) interference feedback. The DL interference feedback may be transmitted to the base station together with, and independently from, the SRS transmission to indicate information that may be otherwise determined by the base station upon receiving the SU CQI/RI. As a result, the base station may not need to transmit the beamformed CSI-RS used by the UE to feedback the SU CQI/RI, which may thereby reduce a number of communications among the UE and the base station for receiving the PDSCH to two round-trip cycles of transmissions/receptions, rather than three round-trip cycles. A reduction in the number of required communications may both improve the system latency and reduce the overhead from CSI-RS.

In an aspect of the disclosure, a method, a computer-readable medium, and an apparatus are provided. The apparatus may be a wireless device at a UE that includes a memory and at least one processor coupled to the memory. The memory may include instructions that, when executed by the at least one processor, cause the at least one processor to receive, from a base station, a configuration for a CSI report setting for DL interference feedback. The configuration may include information indicating a measurement resource on which an interference measurement is performed for generating the DL interference feedback. The at least one processor may be further configured to transmit, to the base station, a SRS and the DL interference feedback, where the DL interference feedback is independent of the SRS; and receive, from the base station, pre-committed CSI-RS based on the transmission of the SRS and the DL interference feedback.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and a UE in an access network.

FIG. 4 is a call flow diagram illustrating communications between a UE and a base station.

FIG. 5 illustrates a diagram corresponding to operations for reciprocity-based precoding.

FIG. 6 is a diagram that illustrates DL interference feedback from a UE to a base station.

FIGS. 7A-7B are diagrams associated with a CSI report setting for a UE.

FIG. 8 is a flowchart of a method of wireless communication of a UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

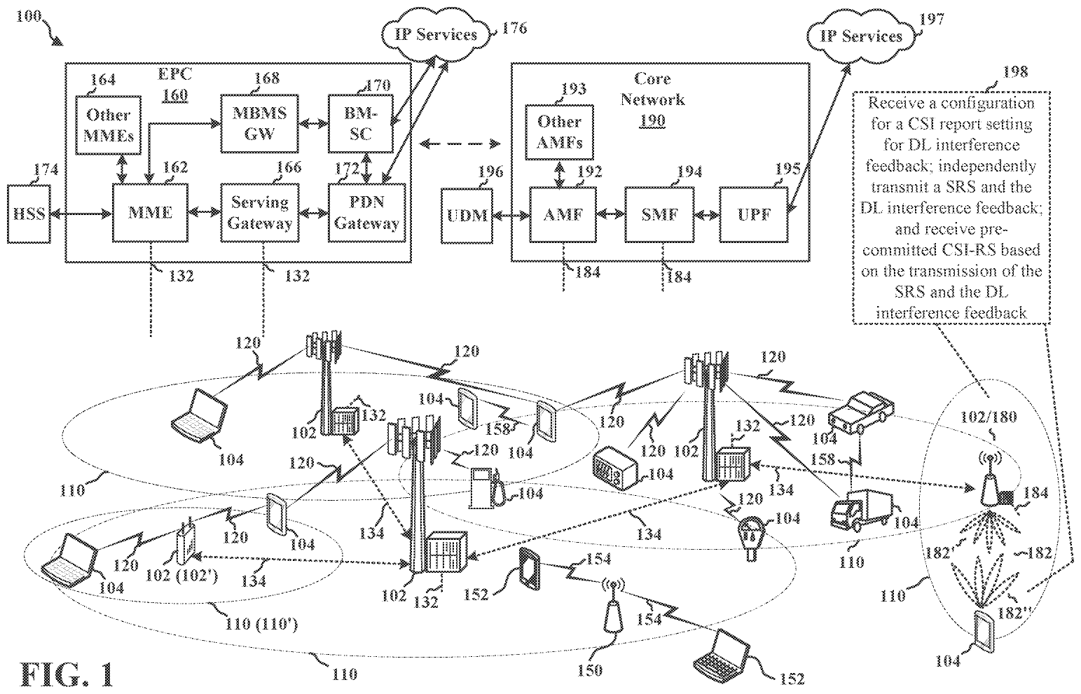

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), intercell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the <UE 104/base station 180> may be configured to receive a configuration for a CSI report setting for DL interference feedback; independently transmit a SRS and the DL interference feedback; and receive pre-committed CSI-RS based on the transmission of the SRS and the DL interference feedback (198). Although the following description may be focused on 5G NR, the concepts described herein may be applicable to other similar areas, such as LTE, LTE-A, CDMA, GSM, and other wireless technologies.

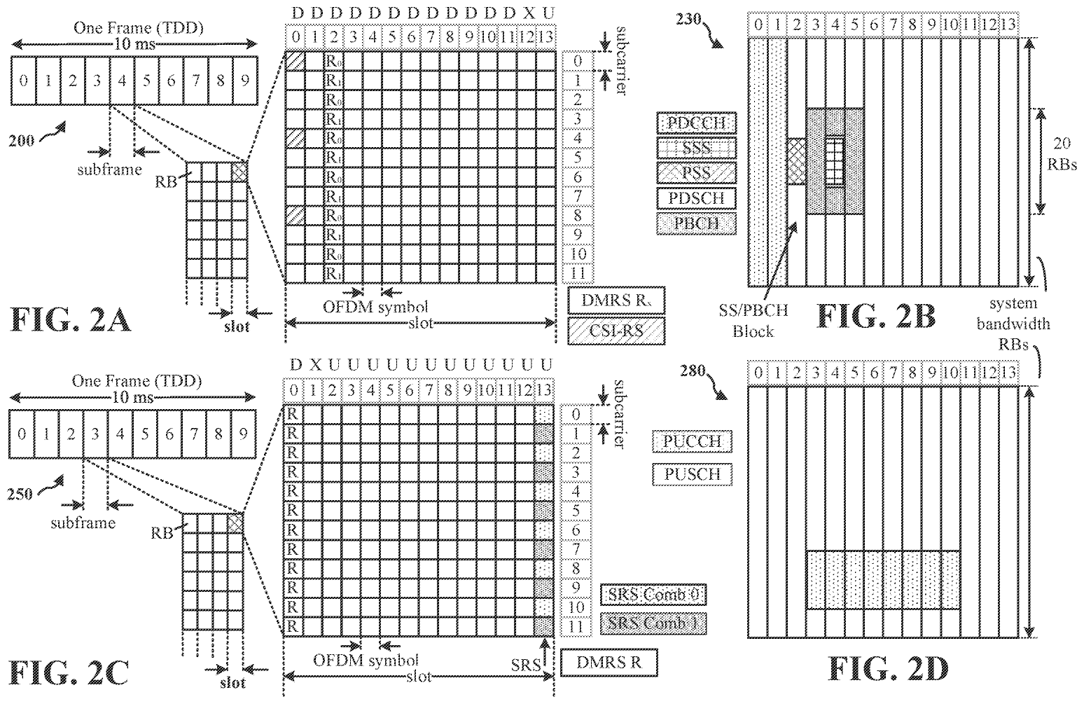

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

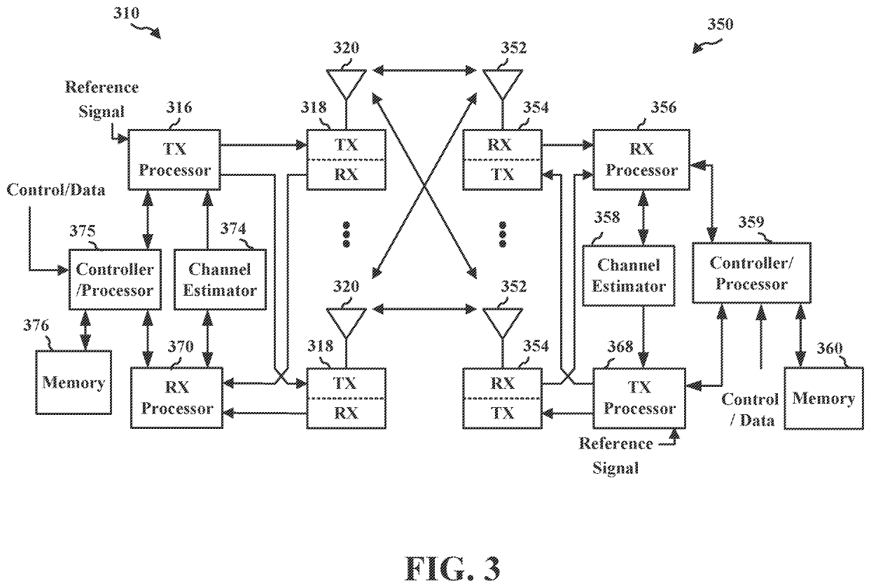

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

Wireless communication systems may be configured to share available system resources and provide various telecommunication services (e.g., telephony, video, data, messaging, broadcasts, etc.) based on multiple-access technologies such as CDMA systems, TDMA systems, FDMA systems, OFDMA systems, SC-FDMA systems, TD-SCDMA systems, etc. that support communication with multiple users. In many cases, common protocols that facilitate communications with wireless devices are adopted in various telecommunication standards. For example, communication methods associated with eMBB, mMTC, and URLLC may be incorporated in the 5G NR telecommunication standard, while other aspects may be incorporated in the 4G LTE standard. As mobile broadband technologies are part of a continuous evolution, further improvements in mobile broadband remain useful to continue the progression of such technologies.

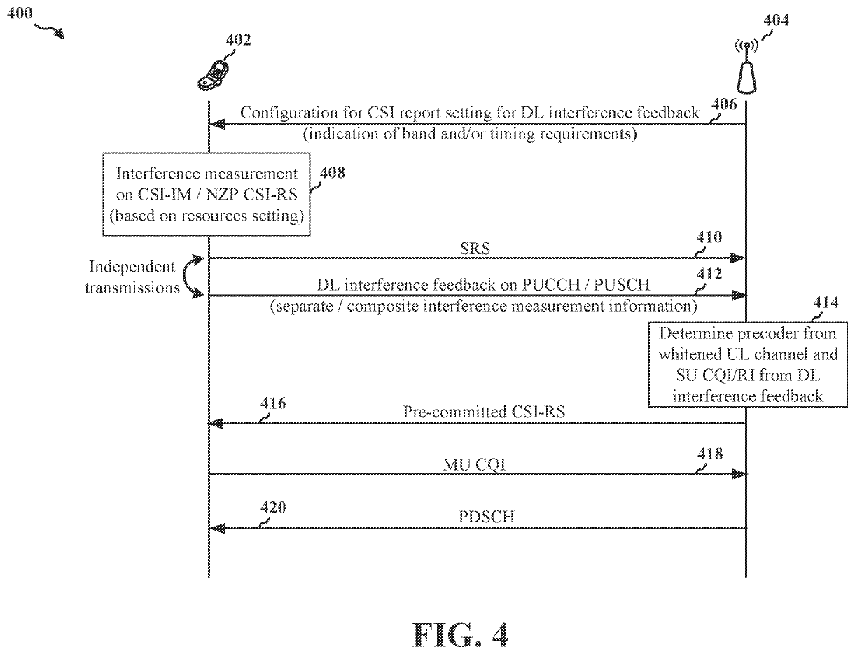

FIG. 4 is a call flow diagram 400 illustrating communications between a UE 402 and a base station 404. At 406, the UE 402 may receive from the base station 404 a configuration for a CSI report setting for DL interference feedback. The configuration may include information indicating a measurement resource on which an interference measurement may be performed by the UE 402 for generating the DL interference feedback for the base station 404. The configuration may indicate that the interference measurement on the measurement resource may be performed on a periodic basis, a semi-persistent basis, or an aperiodic basis and/or a timing parameter to enable/disable an average time between performing interference measurements. The configuration may further indicate whether wideband or subband interference is to be reported to the base station 404 and/or a band for performing CSI reporting.

At 408, the UE 402 may perform the interference measurement on at least one of a CSI-interference measurement (CSI-IM) resource or a non-zero power (NZP) CSI-RS resource. The CSI report setting received by the UE 402 may include one resource setting associate with either the CSI-IM resource or the NZP CSI-RS resource, or the CSI report setting received by the UE 402 may include two resource settings where a first resource setting is associated with the CSI-IM resource and a second resource setting is associated with NZP CSI-RS.

At 410-412, the UE 402 may transmit a SRS and the DL interference feedback to the base station 404 independently from one another. The DL interference feedback may be transmitted to the base station 404 on a PUCCH or a PUSCH on any of a periodic basis, semi-persistent basis, or aperiodic basis. The DL interference feedback may report separate interference information for the CSI-IM resource and the NZP CSI-RS resource. Additionally or alternatively, the DL interference feedback may report composite interference information indicative of a cumulative interference from the CSI-IM resource and the NZP CSI-RS resource.

At 414, the base station 404 may determine a precoder for pre-committed CSI-RS based on a whitened UL channel including the SRS and the DL interference feedback. The base station 404 may further determine single-user (SU) CQI/RI information associated with the DL interference feedback to transmit pre-committed CSI-RS. At 416 the UE 402 may receive the pre-committed CSI-RS transmitted by the base station 404 based on the determine precoder and SU CQI/RI.

At 418, the UE 402 may transmit multi-user (MU) CQI to the base station 404 based on the pre-committed CSI-RS and, at 420, the UE 402 may receive a PDSCH transmission based on the MU CQI transmitted to the base station 404 by the UE 402.

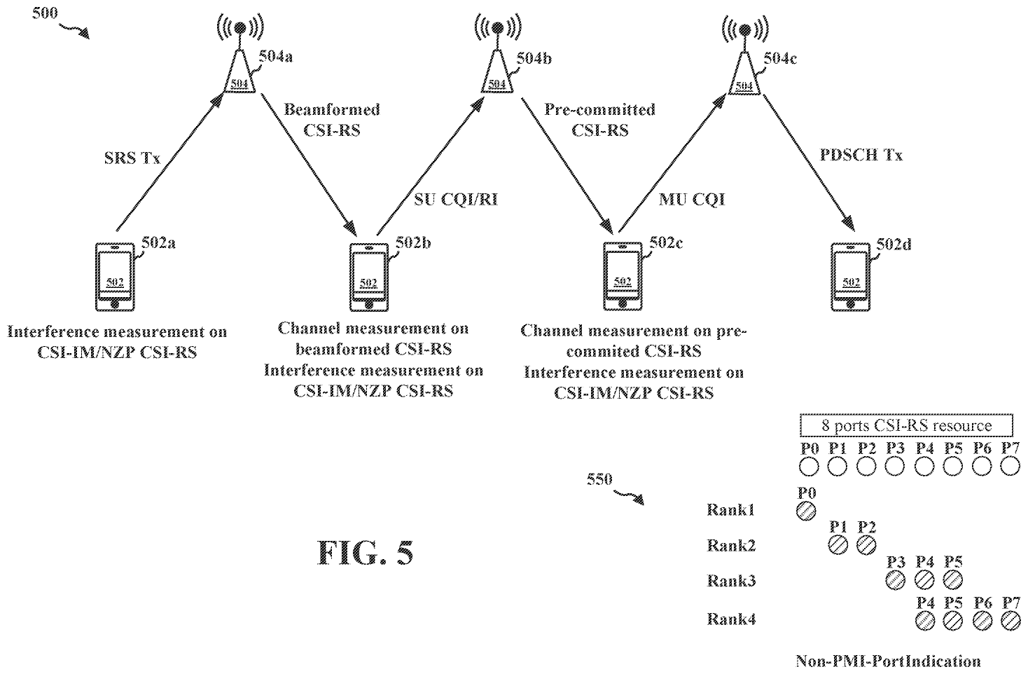

FIG. 5 illustrates a diagram 500 that corresponds to operations for reciprocity-based precoding. The UE 502 may be configured at 502a to transmit a SRS in UL for performing an interference measurement on a CSI-IM resource and/or a NZP CSI-RS resource. While interference conditions at the UE 502 may not be directly identified by the base station 504, the base station 504 may be configured to determine a desired PDSCH precoding based on a measurement of the SRS received, at 504a, from the UE 502. In aspects, the base station 504 may determine, at 504a, a precoding for a CSI-RS based on the SRS and a reciprocity with the UE 502. The precoding may be used by the base station 504 to transmit a beamformed CSI-RS to the UE 502.

At 502b, the UE 502 may perform a channel measurement on the beamformed CSI-RS received in DL from the base station 504. For example, the UE 502 may perform an interference measurement on a CSI-IM resource and/or a NZP CSI-RS resource to determine a SU CQI/RI that may be transmitted as feedback to the base station 504. The transmission at 502b may include a channel restart indicator (cri)-RI-CQI that is configured based on a CSI-ReportConfig parameter. In aspects, the transmission at 502b may include non-PMI feedback that is used by the base station 504 to perform precoding for the reciprocity-based operation.

The base station 504 may transmit, at 504b, pre-committed CSI-RS based on a MU multiple-input-multiple-output (MIMO) configuration. That is, the pre-committed CSI-RS may correspond to a prescheduling of the CSI-RS for which different UEs identified by the base station 504 for the MU-MIMO configuration may each receive a same precoding of the CSI-RS. In the MU-MIMO configuration, the precoding for the pre-committed CSI-RS may be based on both the SU CQI/RI and an SU precoding determined via the SRS. The base station 504 may precode the CSI-RS in a similar manner to a PDSCH precoding. The UE 502 may select a desired RI and determine a corresponding CQI based on antenna ports of the beamformed CSI-RS, wherein the UE 502 may assume that an identity matrix was used as the precoding matrix over the corresponding CSI-RS ports. A CSI-RS port (e.g., included in the CSI-RS ports 550) that the UE 502 may use for a rank hypothesis may be indicated in a CSI report setting via a non-PMI-PortIndication parameter.

At 502c, the UE 502 may perform a channel measurement on the pre-committed CSI-RS received in DL by the UE 502. For example, the UE 502 may perform an interference measurement on a CSI-IM resource and/or a NZP CSI-RS resource to determine a MU CQI that may be transmitted as feedback to the base station 504. Based on the MU CQI received from the UE 502, the base station 504 may transmit, at 504c, a PDSCH that may be received by the UE 502, at 502d. Thus, three round-trip cycles of transmissions/receptions among the UE 502 and the base station 504 may be required between transmitting the SRS at 502a and receiving the PDSCH at 502d, since interference information at the UE 502 may not be directly determined by the base station 504.

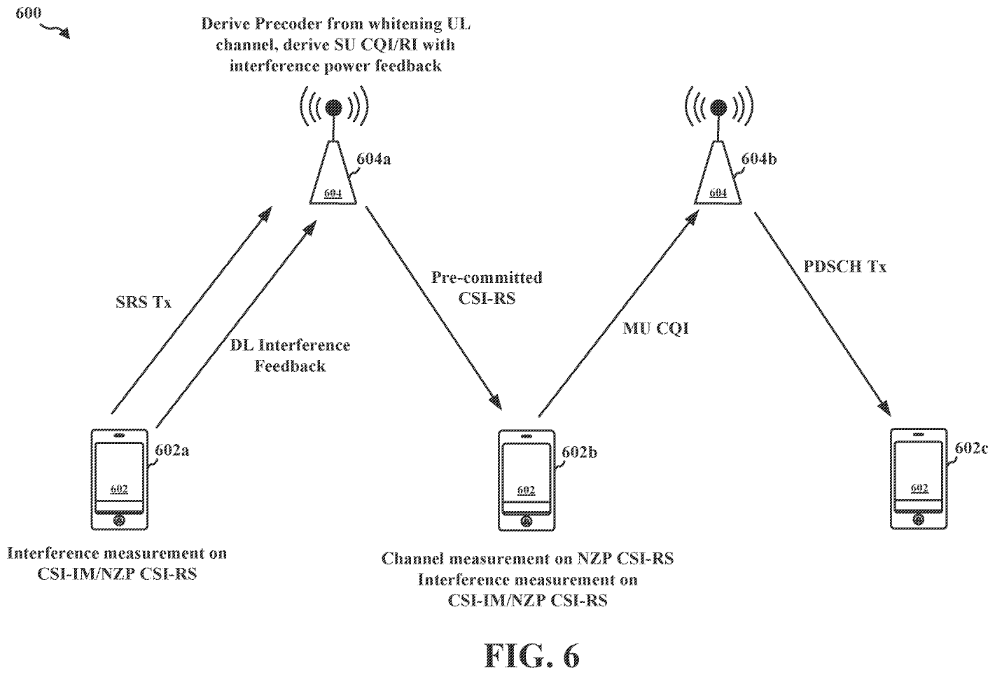

FIG. 6 is a diagram 600 that illustrates DL interference feedback from a UE 602 to a base station 604. Interference/power feedback may be utilized by the base station 604 to improve CSI feedback latency and reduce CSI-RS overhead. For example, the base station 604 may determine, at 604a, a SU CQI/RI based on the reported DL interference feedback received from the UE 602. As such, the base station 604 may not need to wait for/receive the SU CQI/RI (e.g., that may be otherwise received at 504b in the diagram 500) to precode the pre-committed CSI-RS. Instead, the base station 604 may derive a precoder for the pre-committed CSI-RS based on a whitened UL channel having the reported DL interference feedback. Thus, the base station 604 may perform such aspects differently from the diagram 500, where the base station 504 may be configured to derive a precoder for a SU configuration based on the UL channel not including any interference information and then derive another precoder for the pre-committed CSI-RS based on the SU CQI/RI subsequently received at 504b and/or the precoder previously derived for the SU configuration.

Because the base station 604 may determine the CQI/RI based on the DL interference feedback, the base station 604 may not need to transmit the beamformed CSI-RS (e.g., that may be otherwise transmitted at 504a in the diagram 500). Overhead from the CSI-RS may be reduced by virtue of not requiring the UE 602 to measure (e.g., in the SU configuration) a beamformed CSI-RS that may otherwise need to be transmitted to the UE 602 in the DL. By removing a need for transmitting the beamformed CSI-RS corresponding to the transmission at 504a, only two round-trip cycles of transmissions/receptions may occur in the diagram 600 among the UE 602 and the base station 604 between transmission of the SRS at 602a and reception of the PDSCH at 602c, as opposed to three round-trip cycles in the diagram 500. As such a lower latency may be provided and/or an improved technique for tracking a variation of the interference that may be caused by bursts in the network traffic.

Accordingly, in the diagram 500, interference information may be implicitly determined by the base station 504 based on quantized spectrum efficiencies/signal-to-noise ratio (SNR) of the CQI, as the base station 504 may not be configured to determine the interference information directly. Further, the interference information in the diagram 500 may need to be determined independently from the SRS transmission. In the diagram 600, the base station 604 may determine the interference information corresponding to the CQI based on reception of the interference/power feedback received at 604a together with the SRS for transmitting the pre-committed CSI-RS. At 602b, the UE 602 may measure the channel on NZP CSI-RS and measure the interference on CSI-IM and/or NZP CSI-RS to report a MU CQI to the base station 604. The base station 604 may subsequently transmit, at 604b, a PDSCH to the UE 602 based on the MU CQI received from the UE 602.

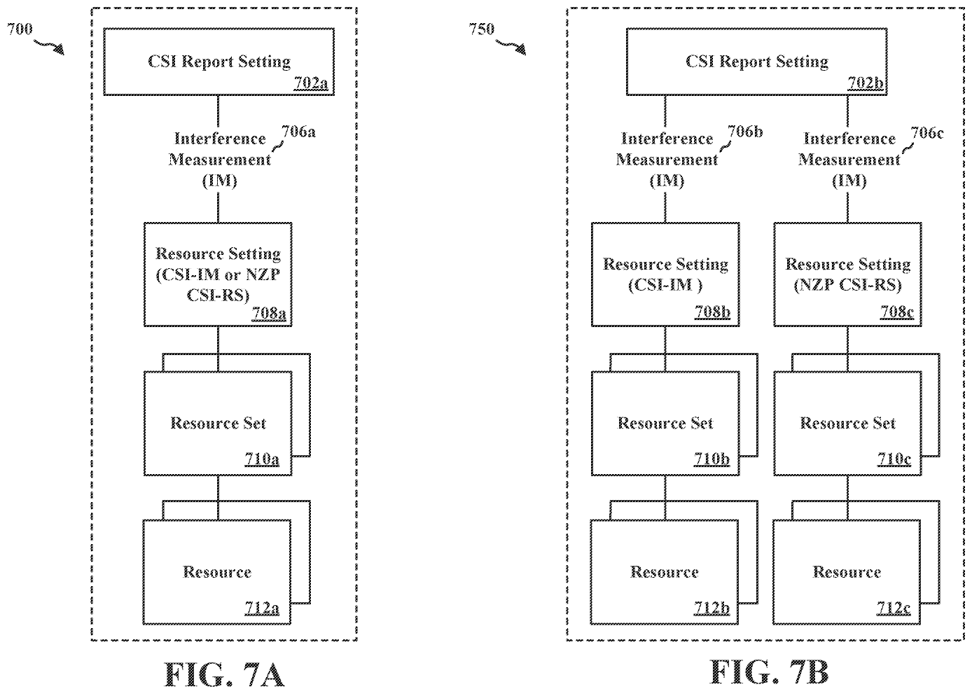

FIGS. 7A-7B are diagrams 700-750 associated with a CSI report setting for a UE. In aspects, the UE may be configured with the CSI report setting to perform an interference measurement that may be indicated to a base station together with, but independently from, a SRS transmission. The CSI report setting may be configured for a single CSI reporting band within a single DL bandwidth part (BWP) and may be further configured based on one or more parameters of the CSI reporting band. The configuration received from the base station may include information indicating a resource setting/measurement resource on which an interference measurement may be performed by the UE.

The resource setting utilized for performing the interference measurement may be configured based on at least one of a CSI-IM resource or a NZP CSI-RS resource. For example, the diagram 700 includes a single resource setting that may be configured for an interference measurement on one of CSI-IM or NZP CSI-RS resources, whereas the diagram 750 includes two resource settings that may be configured for interference measurements on both the CSI-IM and the NZP CSI-RS resources, respectively. That is, the CSI report setting in the diagram 750 may include a first resource setting that is configured based on CSI-IM and a second resource setting that is configured based on NZP CSI-RS. Each of the resource settings may be associated with one or more resource sets corresponding to one or more resources.

When the UE receives a configuration for a CSI report setting having one resource setting, the resource setting may be for an interference measurement performed on either CSI-IM or NZP CSI-RS resources. The one resource setting of the configuration may be indicated based on a higher layer parameter of csi-IM-ResourcesForInterference or by the higher layer parameter of nzp-CSI-RS-ResourcesForInterference. When the UE receives a configuration for a CSI report setting having two resource settings, a first resource setting may be for interference measurement performed on a CSI-IM resource and a second resource setting may be for interference measurement performed on NZP CSI-RS resource. The two resource settings of the CSI report setting may be similarly indicated based on the higher layer parameter of csi-IM-ResourcesForInterference and the higher layer parameter of nzp-CSI-RS-ResourcesForInterference, respectively.

In aspects, CSI-IM resources may be used for measuring intercell interference and NZP CSI-RS resources may be used for measuring intra-cell intracell interference. In either case, interference measurements performed on the measurement resources may occur on any of a periodic basis, a semi-persistent basis, or an aperiodic basis. Upon the UE transmitting an indication of the interference measurements to the base station (e.g., via the DL interference feedback), the base station may precode the pre-committed CSI-RS in a manner that accounts for each UE in an MU MIMO configuration that may receive the pre-committed CSI-RS. A UE that receives the pre-committed CSI-RS may determine how the channel has modified the CSI-RS or the CSI-IM in order to transmit the MU CQI back to the base station, so that the base station may further transmit a PDSCH to the UE based on a same precoder used for transmitting the pre-committed CSI-RS.

The interference measurement information transmitted to the base station may be based on either separate reporting or composite reporting of information associated with the measurement resources. For example, separate reporting may include indicating to the base station respective interference information associated with each of the CSI-IM and the NZP CSI-RS. In contrast, composite reporting may include indicating to the base station cumulative interference information (e.g., indicative of a single value) that results from a combined effect of both the CSI-IM and the NZP CSI-RS (e.g., when the CSI report setting is configured with two resource settings). Separate reporting and composite reporting may be performed in accordance with both standard CSI report settings and CSI-report settings that are based on interference measurement.

When multiple resources are configured for one resource set of an interference measurement, CRI information may be required to report/indicate the selected resources. For separate reporting, if the resource setting is configured for CSI-IM resources, a CRI/CSI-IM reference signal received power (RSRP) may be associated with an intercell interference measurement, where the CSI-IM resources may be shared with other UEs within the serving cell. If the resource setting is configured for NZP CSI-RS, a CRI/NZP CSI-RS RSRP may be associated with an intracell interference measurement, where a configuration for the NZP CSI-RS resources may be UE-specific configuration. The report that indicates the interference measurement information to the base station may be transmitted to the base station on a periodic basis, a semi-persistent basis, or an aperiodic basis. A reporting frequency may be further based on whether wideband interference or subband interference is being reported. Further, the report may be transmitted to the base station on either a PUCCH or a PUSCH.

A time restriction for the CSI report setting may be configured (e.g., as on or off) to enable or disable a time domain average for measuring the interference. In aspects where channel measurements are not performed, codebook information may not be needed for configuring the CSI report setting to measure the interference and to feedback the power to the base station. The UE may determine that the CSI-IM or NZP CSI-RS for the interference measurement and the pre-committed CSI-RS may be quasi co-located (QCLed) based on a QCL-TypeD spatial parameter (e.g., a same RSRP may be reused for the UE to receive the reference signal). If both CSI-IM and NZP CSI-RS are configured for interference measurement, the UE may determine that the CSI-IM and NZP CSI-RS for one reporting may be QCLed based on the QCL-TypeD spatial parameter.

In an example, the UE may be configured to determine the cumulative interference from the NZP CSI-RS and the CSI-IM. When two resource settings are configured, the first resource setting may be for intercell interference measurement performed on CSI-IM and the second resource setting may be for intracell (e.g., MU MIMO inter-UE) interference measurement performed on NZP CSI-RS. An interference covariance matrix for estimating the CSI-IM may be expressed as:

$${R}_{CSI - IM} = \frac{1}{K} {\sum }_{k = 0}^{k = K - 1} {y}_{k} {y}_{k}^{H} ,$$

where yₖ is a received signal on a CSI-IM resource element (RE) k and K is a number of the REs in the CSI-IM or an averaging region. Given Hᵢ, i=1, . . . , N−1 as estimated channels from the NZP CSI-RS resources for interference measurement, P_{c}⁽ⁱ⁾ may indicate a ratio of the PDSCH energy per resource element (EPRE) to the NZP CSI-RS EPRE for the resource i. The total interference covariance matrix R may be determined based on: R=R_{CSI-IM}+Σᵢ₌₁^{N-1}P_{c}⁽ⁱ⁾HᵢHᵢ^{H}, such that the reported RSRP=mean(ΣᵢR_{i,i}), where ΣᵢR_{i,i}, where Eᵢ R_{i,i} is the sum of all diagonal elements of matrix R.

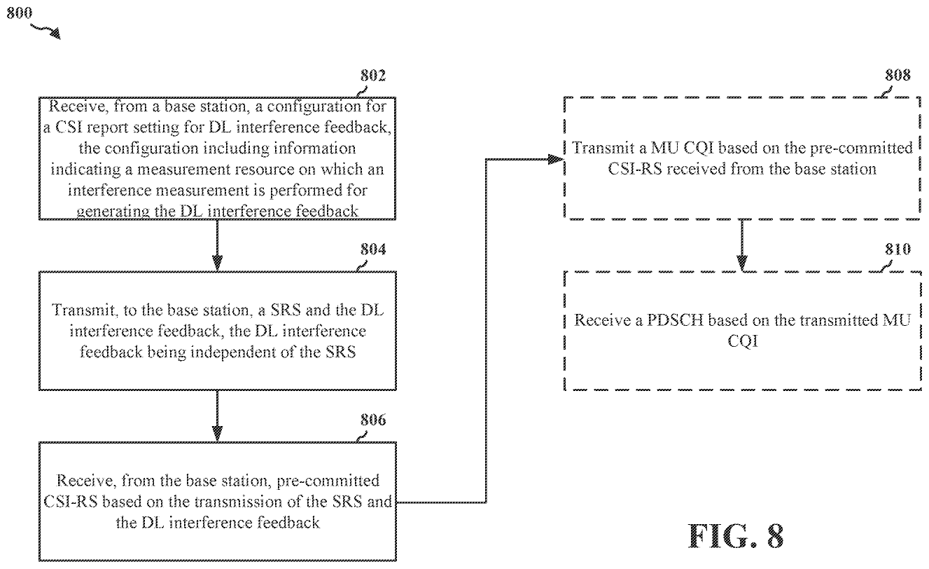

FIG. 8 is a flowchart 800 of a method of wireless communication. The method may be performed by a UE (e.g., the UE 602), which may include the memory 360 and which may be the entire UE 602 or a component of the UE 602, such as the TX processor 368, the RX processor 356, and/or the controller/processor 359.

At 802, the UE may receive, from a base station, a configuration for a CSI report setting for DL interference feedback, the configuration including information indicating a measurement resource on which an interference measurement is performed for generating the DL interference feedback. For example, referring to FIGS. 6-7B, the UE 602 may receive a configuration for the CSI report setting 702a-b that includes one or more resources 712a-c on which an interference measurement 708a-c is performed by the UE 602 to generate the DL interference feedback at 602a.

The measurement resource may be at least one of a CSI-IM resource or a NZP CSI-RS resource. For example, referring to FIGS. 6-7B, the UE 602 may perform the interference measurement 706a-c (e.g., at 602a) via CSI-IM/NZP CSI-RS resources. The CSI report setting may include a first resource setting and a second resource setting, the first resource setting being associated with CSI-IM and the second resource setting being associated with NZP CSI-RS. For example, referring to FIG. 7B, the CSI report setting 702b may include the resource setting 708b for CSI-IM resources and the resource setting 708c for NZP CSI-RS resources. The DL interference feedback may include separate interference measurement information for the CSI-IM resource and the NZP CSI-RS resource. For example, referring to FIG. 6, the DL interference feedback transmitted by the UE 602 at 602a may report separate information for the CSI-IM and NZP CSI-RS resources. In other aspects, the DL interference feedback may include composite interference measurement information indicative of a combined interference of the CSI-IM resource and the NZP CSI-RS resource. For example, referring to FIG. 6, the DL interference feedback transmitted by the UE 602 at 602a may report information associated with a combined interference measurement for the CSI-IM and NZP CSI-RS resources.

The CSI report setting (e.g., 702a-b) may be configured for a CSI reporting band within a DL BWP. The configuration for the interference measurement (e.g., 706a-c) may be for at least one of a periodic, a semi-persistent, or an aperiodic measurement on the measurement resource (e.g., 712a-c). Additionally or alternatively, the configuration may include a time restriction to enable or disable a time domain average of the interference measurement (e.g., 706a-c). For example, referring to FIGS. 6-7B, the UE 602 may receive the configuration for the interference measurement 706a-c based on timing requirements for measuring the interference at 706a-c and/or transmitting the DL interference feedback at 602a. In further aspects, the configuration may include information indicating whether wideband interference or subband interference for the measurement information for the interference measurement 706a-c should be reported in the DL interference feedback transmitted at 602a.

At 804, the UE may transmit, to the base station, a SRS and the DL interference feedback, the DL interference feedback being independent of the SRS. For example, referring to FIG. 6, the UE 602 may independently transmit, at 602a, the SRS and the DL interference feedback to the base station 604. The DL interference feedback may be transmitted (e.g., at 602a to the base station 604) on at least one of a periodic basis, a semi-persistent basis, or an aperiodic basis on at least one of a PUCCH or a PUSCH.

At 806, the UE may receive, from the base station, pre-committed CSI-RS based on the transmission of the SRS and the DL interference feedback. For example, referring to FIG. 6, the UE 602 may receive pre-committed CSI-RS at 602b from the base station 604 based on the base station 604 receiving the SRS and the DL interference feedback at 604a from the UE 602. The measurement resource (e.g., 712a-c) and the pre-committed CSI-RS (e.g., received at 602b) may be configured to be QCLed based on a QCL-TypeD spatial Rx parameter, where the UE 602 may receive the measurement resource (e.g., 712a-c) and the pre-committed CSI-RS (e.g., at 602b) based on the QCL configuration. In further aspects, the UE 602 may be configured to receive CSI-IM and NZP CSI-RS in the measurement resource (e.g., 712a-c), where the CSI-IM and the NZP CSI-RS may be configured to be QCLed based on the QCL-TypeD spatial Rx parameter, and where the UE 602 may receive the CSI-IM and the NZP CSI-RS based on the QCL configuration.

At 808, the UE may transmit a MU CQI based on the pre-committed CSI-RS received from the base station. For example, referring to FIG. 6, the UE 602 may transmit, at 602b, the MU CQI to the base station 604 based on the pre-committed CSI-RS transmitted from the base station 604 at 604a and received by the UE 602 at 602b.

At 810, the UE may receive a PDSCH based on the transmitted MU CQI. For example, referring to FIG. 6, the UE 602 may receive a PDSCH transmission at 602c from the base station 604 based on the MU CQI received by the base station 604 at 604b and transmitted by the UE 602 at 602b.

Accordingly, interference/power feedback from the UE to the base station may be utilized to improve CSI feedback latency and reduce CSI-RS overhead. More specifically, the UE may perform an interference measurement on a measurement resource (e.g., CSI-IM and/or NZP CSI-RS) to generate DL interference feedback. The DL interference feedback may be transmitted to the base station together with, and independently from, the SRS transmission to indicate information that may be otherwise determined by the base station upon receiving the SU CQI/RI. As a result, the base station may not need to transmit the beamformed CSI-RS used by the UE to feedback the SU CQI/RI, which may thereby reduce a number of communications among the UE and the base station for receiving the PDSCH to two round-trip cycles of transmissions/receptions, rather than three round-trip cycles. A reduction in the number of required communications may both improve the system latency and reduce the overhead from CSI-RS.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication of a user equipment (UE), comprising:
receiving, from a base station, a configuration for a channel state information (CSI) report setting for downlink (DL) interference feedback, the configuration including information indicating a measurement resource on which an interference measurement is performed for generating the DL interference feedback;
transmitting, to the base station, a sounding reference signal (SRS) and the DL interference feedback, the DL interference feedback being independent of the SRS; and
receiving, from the base station, pre-committed CSI reference signals (RS) (CSI-RS) based on the transmission of the SRS and the DL interference feedback.

2. The method of claim 1, further comprising:
transmitting a multi-user (MU) channel quality indicator (CQI) based on the pre-committed CSI-RS received from the base station; and
receiving a physical downlink shared channel (PDSCH) based on the transmitted MU CQI.

3. The method of claim 1, wherein the configuration for the interference measurement is for at least one of a periodic, a semi-persistent, or an aperiodic measurement on the measurement resource.

4. The method of claim 1, wherein the CSI report setting is configured for a CSI reporting band within a DL bandwidth part (BWP).

5. The method of claim 1, wherein the measurement resource is at least one of a CSI interference measurement (CSI-IM) resource or a non-zero power (NZP) CSI-RS resource.

6. The method of claim 5, wherein the CSI report setting includes a first resource setting and a second resource setting, the first resource setting being associated with CSI-IM and the second resource setting being associated with NZP CSI-RS.

7. The method of claim 5, wherein the DL interference feedback includes separate interference measurement information for the CSI-IM resource and the NZP CSI-RS resource.

8. The method of claim 5, wherein the DL interference feedback includes composite interference measurement information indicative of a combined interference of the CSI-IM resource and the NZP CSI-RS resource.

9. The method of claim 1, wherein the DL interference feedback is transmitted on at least one of a periodic basis, a semi-persistent basis, or an aperiodic basis on at least one of a physical uplink control channel (PUCCH) or a physical uplink shared channel (PUSCH).

10. The method of claim 1, wherein the configuration includes a time restriction to enable or disable time domain average of the interference measurement.

11. The method of claim 1, wherein the configuration includes information indicating whether wideband interference or subband interference for the measurement information for the interference measurement should be reported in the DL interference feedback.

12. The method of claim 1, wherein the measurement resource and the pre-committed CSI-RS are configured to be quasi co-located (QCLed) based on a QCL-TypeD spatial receive (Rx) parameter, wherein the UE receives the measurement resource and the pre-committed CSI-RS based on the QCL configuration.

13. The method of claim 1, wherein the UE is configured to receive CSI-interference measurement (CSI-IM) and non-zero power (NZP) CSI-RS in the measurement resource, the CSI-IM and the NZP CSI-RS configured to be quasi co-located (QCLed) based on a QCL-TypeD spatial receive (Rx) parameter, the UE receives the CSI-IM and the NZP CSI-RS based on the QCL configuration.

14. An apparatus for wireless communication at a user equipment (UE), comprising:
a memory; and
at least one processor coupled to the memory and configured to:
receive, from a base station, a configuration for a channel state information (CSI) report setting for downlink (DL) interference feedback, the configuration including information indicating a measurement resource on which an interference measurement is performed for generating the DL interference feedback;
transmit, to the base station, a sounding reference signal (SRS) and the DL interference feedback, the DL interference feedback being independent of the SRS; and
receive, from the base station, pre-committed CSI reference signals (RS) (CSI-RS) based on the transmission of the SRS and the DL interference feedback.

15. The apparatus of claim 14, wherein the at least one processor is further configured to:
transmit a multi-user (MU) channel quality indicator (CQI) based on the pre-committed CSI-RS received from the base station; and
receive a physical downlink shared channel (PDSCH) based on the transmitted MU CQI.

16. The apparatus of claim 14, wherein the configuration for the interference measurement is for at least one of a periodic, a semi-persistent, or an aperiodic measurement on the measurement resource.

17. The apparatus of claim 14, wherein the CSI report setting is configured for a CSI reporting band within a DL bandwidth part (BWP).

18. The apparatus of claim 14, wherein the measurement resource is at least one of a CSI interference measurement (CSI-IM) resource or a non-zero power (NZP) CSI-RS resource.

19. The apparatus of claim 18, wherein the CSI report setting includes a first resource setting and a second resource setting, the first resource setting being associated with CSI-IM and the second resource setting being associated with NZP CSI-RS.

20. The apparatus of claim 18, wherein the DL interference feedback includes separate interference measurement information for the CSI-IM resource and the NZP CSI-RS resource.

21. The apparatus of claim 18, wherein the DL interference feedback includes composite interference measurement information indicative of a combined interference of the CSI-IM resource and the NZP CSI-RS resource.

22. The apparatus of claim 14, wherein the DL interference feedback is transmitted on at least one of a periodic basis, a semi-persistent basis, or an aperiodic basis on at least one of a physical uplink control channel (PUCCH) or a physical uplink shared channel (PUSCH).

23. The apparatus of claim 14, wherein the configuration includes a time restriction to enable or disable time domain average of the interference measurement.

24. The apparatus of claim 14, wherein the configuration includes information indicating whether wideband interference or subband interference for the measurement information for the interference measurement should be reported in the DL interference feedback.

25. The apparatus of claim 14, wherein the measurement resource and the pre-committed CSI-RS are configured to be quasi co-located (QCLed) based on a QCL-TypeD spatial receive (Rx) parameter, wherein the UE receives the measurement resource and the pre-committed CSI-RS based on the QCL configuration.

26. The apparatus of claim 14, wherein the UE is configured to receive CSI-interference measurement (CSI-IM) and non-zero power (NZP) CSI-RS in the measurement resource, the CSI-IM and the NZP CSI-RS configured to be quasi co-located (QCLed) based on a QCL-TypeD spatial receive (Rx) parameter, the UE receives the CSI-IM and the NZP CSI-RS based on the QCL configuration.

27. An apparatus for wireless communication at a user equipment (UE), comprising:
means for receiving, from a base station, a configuration for a channel state information (CSI) report setting for downlink (DL) interference feedback, the configuration including information indicating a measurement resource on which an interference measurement is performed for generating the DL interference feedback;
means for transmitting, to the base station, a sounding reference signal (SRS) and the DL interference feedback, the DL interference feedback being independent of the SRS; and
means for receiving, from the base station, pre-committed CSI reference signals (RS) (CSI-RS) based on the transmission of the SRS and the DL interference feedback.

28. The apparatus of claim 27, further comprising:
means for transmitting a multi-user (MU) channel quality indicator (CQI) based on the pre-committed CSI-RS received from the base station; and
means for receiving a physical downlink shared channel (PDSCH) based on the transmitted MU CQI.

29. The apparatus of claim 27, wherein the configuration for the interference measurement is for at least one of a periodic, a semi-persistent, or an aperiodic measurement on the measurement resource.

30-34. (canceled)

35. A computer-readable medium storing computer executable code, the code when executed by at least one processor causes the at least one processor to:
receive, from a base station, a configuration for a channel state information (CSI) report setting for downlink (DL) interference feedback, the configuration including information indicating a measurement resource on which an interference measurement is performed for generating the DL interference feedback;
transmit, to the base station, a sounding reference signal (SRS) and the DL interference feedback, the DL interference feedback being independent of the SRS; and
receive, from the base station, pre-committed CSI reference signals (RS) (CSI-RS) based on the transmission of the SRS and the DL interference feedback.
